(19) United States
(12) Patent Application Publication
(10) Pub. No.: US 2013/0061975 A1
(43) Pub. Date: Mar. 14, 2013

(54) AIRCRAFT GROUND SUPPORT HOSE ASSEMBLY

(71) Applicants: David Wayne Leadingham, Bradenton, FL (US); Richard Lawrence Hansen, Parrish, FL (US); Ty Allan Newell, Urbana, IL (US)

(72) Inventors: David Wayne Leadingham, Bradenton, FL (US); Richard Lawrence Hansen, Parrish, FL (US); Ty Allan Newell, Urbana, IL (US)

(21) Appl. No.: 13/232,023

(22) Filed: Sep. 14, 2011

(51) Int. Cl. F16L 59/00

(52) U.S. Cl. 138/149

(57) ABSTRACT

An air delivery hose assembly for use with aircraft ground support equipment provides conditioned air to an on-ground aircraft. The hose assembly includes an impermeable inner liner which forms an air conduit, a stress layer comprising a web of cord material which surrounds the inner liner, and an insulating layer which surrounds the inner liner and the stress layer to thermally insulate air passing through the air hose. The stress layer prevents air pressure in the conduit from expanding the inner liner and compressing the insulating layer, and thereby reducing the effectiveness of the insulating layer.

### CROSS-REFERENCE TO RELATED APPLICATION

None.

### BACKGROUND OF THE INVENTION

I. Field of the Invention

The present disclosure relates generally to an air supply hose assembly. In particular, the present disclosure is directed to an air supply hose assembly for supplying pre-cooled air to an on-ground aircraft.

II. Description of the Prior Art

Aircraft on the ground powered up for repair or replenishment often require conditioned air to cool the pilot and to maintain electronics and other support equipment at desired temperatures. Such conditioned air is typically supplied by a ground support cart which is positioned in close proximity to the aircraft. The ground support cart is connected to the aircraft by means of a flexible duct or hose.

Conventional prior design flexible hose assemblies for ground support consist of an impermeable inner liner forming a conduit for the air, a closed cell insulation layer surrounding the inner liner to minimize warming of air passing through the conduit, and an outer liner to protect the insulation layer. Most of these current aircraft supply hose assemblies evolved from air supply hose assemblies used for civilian aircraft that operate at relatively low pressures and small temperature ranges, and therefore have not been satisfactory for military aircraft which require substantially higher pressures and wider temperature ranges. When preconditioned air is forced from a ground support cart to a military aircraft through prior design air supply hose assemblies at higher pressures, the inner liner of the supply hose expands under the pressure and compresses the insulation, resulting in a loss of insulation efficiency and consequent increased warming of the conditioned air as it passes through the hose assembly.

Accordingly, it is a general object of the present disclosure to provide a ground support hose assembly which provides improved insulation efficiency at the higher conditioned air pressures required by military aircraft as well as lower pressure conditions of other Military and Commercial aircraft.

It is a more specific object of the present disclosure to provide a ground support hose assembly which includes an inner stress layer that prevents the inner liner of the hose from expanding as a result of pressurized air in the conduit.

It is a still more specific object of the present disclosure to provide a ground support hose assembly having a woven stress layer composed of high strength cording which prevents the inner liner of the hose assembly from expanding under pressure.

These and other objects, features and advantages of this disclosure will be more clearly understood through a consideration of the following detailed description.

### SUMMARY OF THE INVENTION

According to an embodiment of the present disclosure, there is provided a ground support hose assembly for providing conditioned air from aircraft ground support equipment to an aircraft. The hose includes an inner liner forming an air conduit, a stress layer surrounding the inner liner for preventing the inner liner from expanding when air is forced through the conduit, and an insulating layer covering the stress layer and the inner liner for insulating air in the conduit.

There is also provided an air hose assembly for coupling a ground support cart to an aircraft. The assembly includes a main section having two ends, each of which includes a connector. The main section includes an inner liner forming an air conduit, a stress layer surrounding the inner liner for preventing the inner liner from expanding as a result of air pressure in the conduit, and an insulating layer surrounding the stress layer and the inner liner for insulating air in the conduit.

### BRIEF DESCRIPTION OF THE DRAWINGS

The present disclosure will be more fully understood by reference to the following detailed description of one or more preferred embodiments when read in conjunction with the accompanying drawings, in which like reference characters refer to like parts throughout the views and in which:

FIG. 1 is a perspective view of an aircraft connected to a ground support cart by an air supply hose assembly constructed in accordance with the principles of the present disclosure.

FIG. 2 is a perspective view of the air supply hose assembly shown in FIG. 1.

FIG. 3 is an enlarged perspective view of the central portion of the air supply hose assembly of FIG. 2 partially broken away to show the component parts thereof.

FIG. 4 is a cross-sectional view of the supply hose assembly of FIG. 3 taken along line 4-4 of FIG. 3.

FIG. 5 is a simplified cross-sectional depiction of an aircraft support hose assembly of conventional design illustrating pressurized air expanding the inner liner and undesirably compressing the insulation layer of the assembly.

FIG. 6 is a simplified cross-sectional depiction of an aircraft support hose assembly constructed in accordance with the present disclosure illustrating the effect of the stress layer in preventing pressurized air from expanding the inner liner and compressing the insulation layer of the hose assembly.

FIG. 7 is a plot of pressure vs. heat transfer coefficient of representative conventional ground support hose assemblies A and B of conventional design and a hose assembly C constructed according to the principles of the present disclosure.

FIG. 8 is a table showing delivery air temperature change of conventional prior design hose assemblies A and B of conventional design and a hose assembly C constructed according to the principles of the present disclosure.

### DESCRIPTION OF THE PREFERRED EMBODIMENTS

The following description of the preferred embodiments is merely exemplary in nature and is in no way intended to limit the disclosure, its application or use.

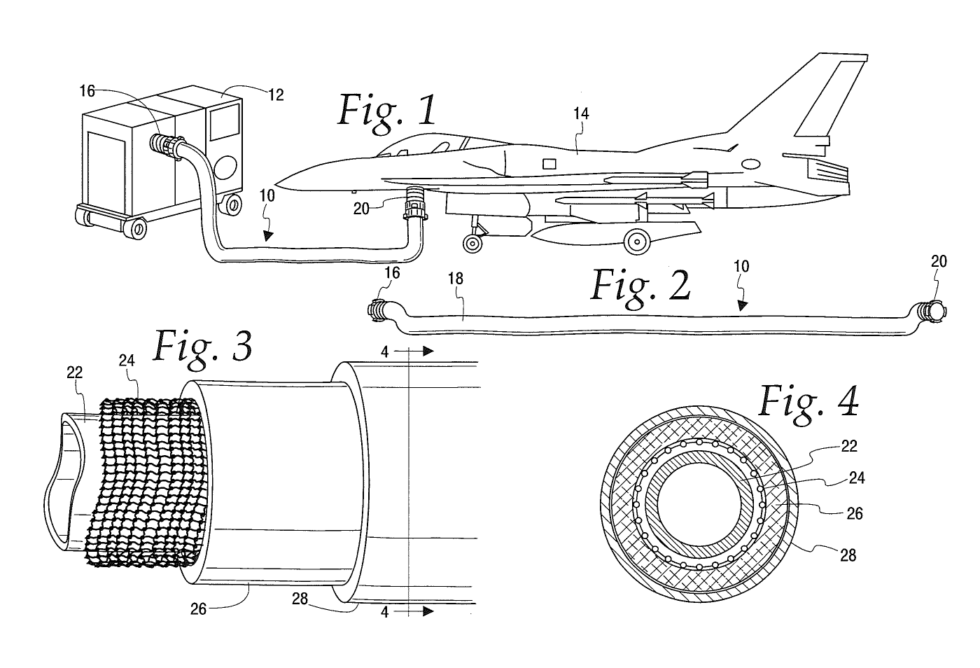

Turning now to the drawings, FIG. 1 illustrates a preconditioned aircraft ground support assembly 10 connected between a conventional ground cart 12, such as the model J03C manufactured by ITW Military GSE, and a high performance military aircraft 14. The air hose assembly 10 delivers conditioned air to aircraft 14 to avoid the need to operate the on board air conditioning system of the aircraft itself while the aircraft is parked, or to supplement the on-board air conditioning to provide additional cooling when the aircraft is operating on the ground. Such conditioned air may provide cooling for avionics or personnel while the aircraft 14 is on the ground.

As shown in FIG. 2, the illustrated ground support hose assembly 10 includes a first connector 16 at one end for connection to ground support cart 12, a center section 18, and a second connector 20 at its other end for connecting to aircraft 14. In further embodiments, the ground support hose assembly 10 may include any number and combination of reinforced sections and/or flat sections, depending on the design specifications for the desired assembly.

FIGS. 3 and 4 illustrate the center section 18 of the ground support hose assembly 10 in more detail. The center section 18 includes an impermeable inner liner 22, a stress layer 24 surrounding the inner liner, an insulation layer 26 surrounding the inner liner 22 and stress layer 24, and an outer scuff covering layer 28 surrounding the inner liner 22, stress layer 24 and insulation layer 26. The inner liner 22 can be fabricated from a variety of impermeable materials such as vinyl with a fabric scrim or mesh embedded therein. The diameter of the liner 22 depends on the air delivery requirements of the application, but generally ranges from 4 to 14 inches.

The stress layer 24 is adjacent to and envelops the impermeable liner 22. The stress layer 24 is preferably fabricated as an open weave of a high strength cord or rope material. The weave density is determined by various factors, including the material strength of the cord, the air pressure in assembly 10, and the diameter of inner liner 22. Low pressure applications would use a lighter cord and a more open weave while higher pressure applications would require a thicker cord and a denser weave. The woven cord stress layer 24 adds strength to the hose assembly, while still allowing flexibility when the hose assembly is deflated. Moreover, stress layer 24 prevents inner liner 22 from expanding as a result of air pressure in assembly 10, thus preventing compression of insulating layer 26.

Insulation layer 26 surrounds and envelops the inner impermeable liner 22 and the woven stress layer 24. The thickness of insulation layer 26 is based on the amount of insulation required to minimize temperature increase from surrounding ambient air as cooled conditioned air passes through the ground support hose assembly. The insulation may be either an “open cell” or “closed cell” construction. Open cell insulation, such as open cell foam insulations and fibrous insulations (e.g., polyester batting) is used when it is important to be able to collapse or fold the hose and when moisture absorption in the insulation does not create difficulties. Closed cell insulation, such as closed cell foams, preferably in ½ inch thick polyethylene sheets, is used when moisture is expected that would cause problems for open cell insulations. In either case, the insulating layer 26 may or may not contain a reflective layer.

The outer covering 28 is primarily for protection from abrasion and adverse environmental conditions. The outer layer should be as thin as possible while providing the required protection and flexibility.

The current weaving method for stress layer 24 is a simple process. After the weaving process is completed, the inner liner 22 is pulled through the stress layer, and the insulation layer 26 is wrapped and glued around the, stress layer. After this, the outer shell or outer covering 28 is wrapped around the insulation layer.

The resultant hose assembly 10 of the present disclosure is flexible, collapsible and of high strength. Most conventional aircraft supply hoses of conventional design have evolved from air supply hoses used for civilian aircraft that operate at lower pressures and less severe temperature ranges. Military requirements have introduced new pressure levels, such as those required, for example, by the F-35 fighter jet, thereby requiring new concepts in conditioned air supply hoses. As previously discussed, one such problem among conventional hose designs with higher pressure is that the insulation layer is crushed between the inner liner and the outer shell. Crushing the insulation layer reduces insulation resistance and decreases hose flexibility. As a result, the temperature loss in conventional prior design hoses at high ambient temperatures would require the ground conditioning cart to supply subfreezing air. The subject hose assembly of the present disclosure resolves this issue.

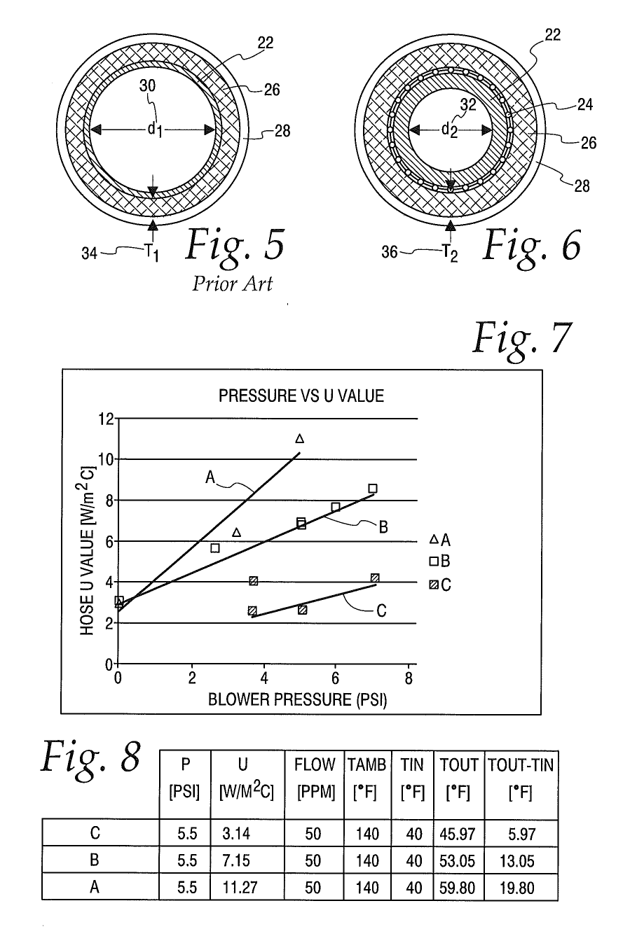

More particularly, as shown in FIG. 5, without the stress layer 24 of the present disclosure, the inner liner 20 of a conventional aircraft support hose assembly expands to a diameter d₁ (30) under the pressure of conditioned air. By contrast, and as shown by FIG. 6, in a hose assembly constructed in accordance with the present disclosure, the inner liner 22 remains at its design diameter d₂ (32) under the pressure of conditioned air because expansion is prevented by stress layer 24. Consequently, the thickness of the insulation layer 26 is undesirably reduced to T₁ (34) in FIG. 5, while the thickness of the insulation layer in FIG. 6 remains at T₂ (36). Thus, as conditioned air is forced under pressure through a conventional hose assembly, the diameter of the inner liner expands to d₁ and the insulation layer is compressed to T₁. However, as conditioned air is forced under pressure through a hose assembly of the present design, the diameter of the inner liner remains constant at d₂, which leaves the thickness of the insulating layer constant at T₂.

In practice, a typical non-military commercial aircraft may require conditioned air to be delivered at approximately 1 psig pressure. In contrast, a military fighter aircraft may require approximately 5 psig. Consequently, the internal liner of a conventional ground support hose when used to supply conditioned air to a military aircraft expands with the increased air pressure and crushes its insulation layer against its outer layer (see FIG. 5). This crushing of the insulation layer results in loss of the R-factor of the insulation layer, causing the cool conditioned air passing through the hose assembly to pick up heat and the conditioning cart to have to work harder in order to meet the temperature requirements of the aircraft.

The advantage of the hose assembly of the present disclosure over conventional hose assemblies is further illustrated in FIGS. 7 and 8. FIG. 7 is a plot of heat transfer data that compares a first exemplary hose assembly A of conventional construction and a second exemplary hose assembly B of conventional construction to a high performance hose assembly C constructed in accordance with the present disclosure. The hose assembly “U value”, or its overall heat transfer coefficient, is plotted against the hose pressure. As pressure increases, the A and B hose assemblies lose insulation value as indicated by the respective increasing U values. By contrast, the subject C hose assembly shows only a modest increase in U value at high pressure.

Referring now to FIG. 8, the predicted delivery air temperature change is shown for a 30 foot long 8 inch diameter aircraft ground support hose assembly operating at 5.5 psig with a 50 PPM flow and a 140° F. ambient temperature. The A and B hose assemblies provide increases in delivered air temperature of 19.8° F. and 13.05° F., respectively. By contrast, the subject C hose assembly keeps the air temperature increase below 6° F. at 5.97° F. Thus, the high performance hose assembly C of the present embodiment improves the cooling system's efficiency, maximizes cooling capacity, and minimizes evaporator frosting.

The foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the invention if its broader aspects, and, therefore, the aim in the appended claims is to cover all such changes and modifications as fall within the true spirit and scope of the present disclosure.

1. A ground support hose assembly for providing pre-conditioned air from aircraft ground support equipment to an aircraft, the hose assembly comprising:
an impermeable inner liner forming an air conduit;
a stress layer surrounding said inner liner for preventing said inner liner from expanding when the ground support equipment forces air under pressure through said air conduit; and
an insulation layer surrounding said stress layer and said inner liner for insulating pre-conditioned air as it flow through said air conduit.

2. A ground support hose assembly as defined in claim 1 further including an outer layer surrounding said inner liner, said stress layer and said insulation layer for protecting said hose assembly.

3. A ground support hose assembly as defined in claim 1 wherein said stress layer comprises a mesh formed of high strength cording.

4. A ground support hose assembly for coupling a source of conditioned air to an aircraft, the assembly comprising:
a main section having two ends, each of said ends including a connector, and wherein said main section includes:
an impermeable inner liner forming an air conduit for said conditioned air;
a stress layer surrounding said inner liner for preventing said inner liner from being expanded by conditioned air flowing under pressure in said air conduit; and
an insulation layer surrounding said stress layer and said inner liner for insulating conditioned air flowing in said air conduit.

5. An air hose assembly as defined in claim 4 wherein said main section further includes an outer covering surrounding said insulation layer.

6. An air hose assembly as defined in claim 4 wherein said stress layer comprises a mesh formed of high strength cording.
